(19) United States
(12) Patent Application Publication
(10) Pub. No.: US 2007/0178320 A1
(43) Pub. Date: Aug. 2, 2007

(54) Release film and process for producing the film

(75) Inventors: Jungo Sasaki, Kitamoto-shi (JP); Tomomi Fukaya, Noda-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: LINTEC CORPORATION, Tokyo (JP)

(21) Appl. No.: 11/655,491

(22) Filed: Jan. 18, 2007

(30) Foreign Application Priority Data
Feb. 1, 2006 (JP) 2006-24677

(51) Int. Cl. B32B 7/00; B32B 33/00; B32B 27/00

(52) U.S. Cl. 428/447; 428/352

(57) ABSTRACT

A release film comprising a releasing agent layer which is disposed on at least one of faces of a substrate film and has a hardness of 0.07 GPa or smaller as measured in accordance with a nano indentation test, wherein peeling force has an average value of 100 mN/20 mm or greater and stays within ±7% of the average value when the release film having a width of 20 mm and a length of 150 mm is peeled from a pressure sensitive adhesive layer at an angle of 180° with respect to the face of the adhesive layer at a speed of 0.3 m/minute in measurement of the peeling force. When the release film is peeled from the face of the adhesive layer of a pressure sensitive adhesive product, striation on the surface of the pressure sensitive adhesive layer can be prevented by suppressing zipping.

### TECHNICAL FIELD

The present invention relates to a release film and a process for producing the film. More particularly, the present invention relates to a release film suppressing zipping when the release film is peeled from the face of a pressure sensitive adhesive layer of a pressure sensitive adhesive product and a process for producing the release film.

### BACKGROUND ART

As the protective film for a pressure sensitive adhesive layer in pressure sensitive adhesive products, in general, a release film is used. In the release film, a layer composed of a releasing agent such as a silicone-based resin and a non-silicone-based resin, which is, for example, a compound having a long chain alkyl group or an olefin-based resin, is formed on the surface of a substrate film.

For the release film, in general, the peeling force is adjusted in accordance with the properties of the machine used for the peeling. When a release film released under a smaller force is prepared, in general, a silicone-based releasing agent containing polydimethylsiloxane as the main component is used. When a release film releasing under a greater force is prepared, in general, a substance having a resin structure containing an MQ resin [a resin having M unit composed of (CH₃)₃SiO_{1/2} or CH₂═CH(CH₃)₂SiO_{1/2} and Q unit composed of SiO/_{4/2}] or a substance having a silica structure is added to the above silicone-based releasing agent as the agent for release adjustment (the additive for release under a greater force).

However, when the peeling force is increased to some degree by adding the additive for release under a greater force, zipping occasionally takes place when the release film is peeled from the face of the pressure sensitive adhesive layer. When the release film causing zipping is used as the release film for a pressure sensitive adhesive product, a problem arises in that striation (formation of lines by the peeling) takes place on the face of the pressure sensitive adhesive layer when the release film is peeled from the face of the pressure sensitive adhesive layer. When the zipping takes place, a further drawback arises in that fluctuation in the peeling force increases during the peeling, and the peeling cannot be conducted under a constant force. As the result, occasionally, the apparatus for the production cannot work normally in the production of a pressure sensitive adhesive product using a machine.

Therefore, to overcome the problem of zipping, a technology in which a combination of a specific pressure sensitive adhesive layer and a specific releasing agent layer is used (for example, refer to Patent Reference 1), a technology in which strength of the coating film of the releasing agent layer is controlled (for example, refer to Patent Reference 2) and a technology in which the composition of a silicone-based releasing agent composition is specified (for example, refer to Patent Reference 3) have been proposed.

However, the above technologies are not satisfactory.

[Patent Reference 1] Japanese Patent Application Laid-Open No. Heisei 5(1993)-329184

[Patent Reference 2] Japanese Patent Application Laid-Open No. Heisei 10(1998)-226781

[Patent Reference 3] Japanese Patent Application Laid-Open No. Heisei 9(1997)-291270

### DISCLOSURE OF THE INVENTION

The present invention has been made under the above circumstances and has an object of providing a release film which can prevent striation on the face of a pressure sensitive adhesive layer by suppressing zipping when the release film is peeled from the face of the pressure sensitive adhesive layer of a pressure sensitive adhesive product and decrease fluctuation in the peeling force during peeling and a process for producing the release film.

As the result of intensive studies by the present inventors to achieve the above object, it was found that the object could be achieved with a release film comprising a releasing agent layer having a specific value or smaller of the hardness as measured in accordance with the nano indentation test and providing a peeling force exhibiting specific behavior. The present invention has been completed based on the knowledge.

The Present Invention Provides:

(1) A release film comprising a releasing agent layer which is disposed on at least one of faces of a substrate film and has a hardness of 0.07 GPa or smaller as measured in accordance with a nano indentation test, wherein peeling force has an average value of 100 mN/20 mm or greater and stays within ±7% of the average value when a piece of the release film having a width of 20 mm and a length of 150 mm is peeled from a pressure sensitive adhesive layer at an angle of 180° with respect to a face of the pressure sensitive adhesive layer at a speed of 0.3 m/minute in measurement of the peeling force from the pressure sensitive adhesive layer;

(2) The release film described in (1), wherein the hardness measured in accordance with the nano indentation test is 0.05 to 0.065 GPa;

(3) The release film described in any one of (1) and (2), wherein the average value of the peeling force is 120 to 300 mN/20 mm;

(4) The release film described in any one of (1) to (3), wherein a releasing agent constituting the releasing agent layer is a silicone-based releasing agent;

(5) The release film described in any one of (1) to (4), wherein a thickness of the releasing agent layer is 0.01 to 3 μm; and

(6) A process for producing a release film described in any one of (1) to (5), which comprises coating at least one of faces of a substrate film with a coating fluid comprising a releasing agent and drying a formed coating layer to form a releasing agent layer.

To summarize the advantages of the present invention, the release film which can prevent striation on the face of a pressure sensitive adhesive layer by suppressing zipping when the release film is peeled from the face of the pressure sensitive adhesive layer of a pressure sensitive adhesive product and decrease fluctuation in the peeling force during peeling is provided.

### BRIEF DESCRIPTION OF THE DRAWINGS

FIG. 1 shows a diagram exhibiting the relation between the time and the peeling force in the measurement of the peeling force, wherein (a) shows a diagram obtained when zipping does not take place and (b) shows a diagram obtained when zipping takes place.

### THE MOST PREFERRED EMBODIMENT TO CARRY OUT THE INVENTION

The release film of the present invention is a release film having a releasing agent layer on at least one face of a substrate film.

The substrate film used in the release film of the present invention is not particularly limited and can be suitably selected from substrate films conventionally used as the substrate film of release films in accordance with the application of the release film. Examples of the substrate film include films of polyesters such as polyethylene terephthalate, polybutylene terephthalate and polyethylene naphthalate, polyethylene films, polypropylene films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyphenylene sulfide films, polyether imide films, polyimide films, fluororesin films, polyamide films, acrylic resin films, norbornene-based resin films and cycloolefin resin films.

The thickness of the substrate film is not particularly limited and suitably selected in accordance with the application. In general, the thickness is 10 to 150 μm and preferably 20 to 120 μm.

Where desired, the substrate film may be subjected to a surface treatment such as the oxidation treatment and the roughening treatment or the primer treatment on one or both faces so that adhesion with the releasing agent layer formed on the substrate film is improved. Examples of the oxidation treatment include the treatment by corona discharge, the treatment by plasma discharge, the treatment with chromic acid (a wet process), the treatment with flame, the treatment with the heated air and the treatment with ozone under irradiation with ultraviolet light. Examples of the roughening treatment include the sandblasting treatment and the treatment with a solvent. The surface treatment is suitably selected in accordance with the type of the substrate film. In general, the treatment by corona discharge is preferable from the standpoint of the effect and the operability.

In the present invention, as the releasing agent constituting the releasing agent layer disposed on at least one face of the substrate film, silicone-based releasing agents and non-silicone-based releasing agents such as releasing agents based on compounds having a long chain alkyl group, alkyd resin-based releasing agents, olefin resin-based releasing agents and acrylic resin-based releasing agents can be used. Among these releasing agents, silicone-based releasing agents are preferable.

As the silicone-based releasing agent, silicone-based releasing agents of the addition reaction type are preferable. The silicone-based releasing agent of the addition reaction type is obtained by adding crosslinking agents and catalysts to the main component comprising a silicone resin of the addition reaction type. Where desired, addition reaction suppressors, agents for release adjustment and adhesion improvers may be added. When irradiation with ultraviolet light is conducted in addition to heating in the curing process after the coating with the releasing agent, photo-initiators may be added.

The type of the silicone-based releasing agent is not particularly limited as long as the releasing agent is an agent of the addition reaction type, and any of releasing agents of the solvent type, releasing agents of the emulsion type and releasing agents of the non-solvent type may be used. Releasing agents of the solvent type are preferable from the standpoint of the quality and the easiness of handling.

The silicone-based releasing agent of the addition reaction type is not particularly limited and can be suitably selected from releasing agents conventionally used as the silicone resin releasing agent of the thermosetting addition reaction type. For example, at least one releasing agent selected from polyorganosiloxanes having an alkenyl group in the molecule as the functional group can be used. Examples of the polyorganosiloxanes having an alkenyl group in the molecule as the functional group include polydimethylsiloxane having vinyl group as the functional group, polydimethylsiloxane having hexenyl group as the functional group and mixtures of these compounds.

Examples of the crosslinking agent include polyorganosiloxanes having at least two hydrogen atoms bonded with silicon atom in one molecule such as dimethylsiloxane-methylhydrogensiloxane copolymers having chain ends sealed with dimethylhydrogensiloxy group, dimethyl-siloxane-methylhydrogensiloxane copolymers having chain ends sealed with trimethylsiloxy group, poly(methylhydrogensiloxanes) having chain ends sealed with trimethylsiloxy group and poly(hydrogensilsesquioxane). The amount of the crosslinking agent is selected, in general, in the range of 0.1 to 100 parts by mass and preferably in the range of 0.3 to 50 parts by mass based on 100 parts by mass of the silicone resin of the addition reaction type.

As the catalyst, in general, platinum-based catalysts are used. Examples of the platinum-based catalyst include fine particulate platinum, fine particulate platinum adsorbed with a support of carbon powder, platinic acid chloride, platinic acid chloride modified with an alcohol, olefin complex compounds of platinic acid chloride, palladium and rhodium catalysts. The amount of the catalyst is about 1 to 1,000 ppm as the amount of the platinum-based metal based on the total of the amounts of the silicone resin of the addition reaction type and the crosslinking agents.

Examples of the agent for release adjustment used for releasing agents releasing under a smaller force (the additive for release under a smaller force) include polyorganosiloxanes having no alkenyl group or hydrogen atom bonded to silicon atom in the molecule, specific examples of which include silicone resins such as polydimethylsioxane having chain ends sealed with trimethylsiloxy group and polydimethylsiloxane having chain ends sealed with dimethylphenylsiloxy group.

In the present invention, as the agent for release adjustment used for the releasing agents releasing under a greater force (the additive for release under a greater force), for example, MQ resins having a resin structure having M unit comprising the unit of R¹R²R³SiO_{1/2} (R¹, R² and R³ each independently representing an alkyl group having 1 to 10 carbon atoms which may have a functional group such as hydroxy group, cyano group and epoxy group or vinyl group) and Q unit comprising the unit of SiO_{4/2} and substances having a silica structure comprising a unit of SiO_{4/2} are preferable since it is necessary that a release film providing the peeling force having an average value of 100 mN/20 mm or greater be obtained, as described below.

The amount of the agent for release adjustment is suitably selected in accordance with the desired average value of the peeling force.

The addition reaction suppressor is a component used for providing the composition with the storage stability at the room temperature. Examples of the addition reaction suppressor include 3,5-dimethyl-1-hexyn-3-ol, 3-methyl-1-penten-3-ol, 3-methyl-3-penten-1-yne, 3,5-dimethyl-3-hexen-1-yne, cyclic compounds derived from tetravinylsiloxane and benzotriazole.

Examples of the adhesion improver include silane coupling agents such as vinyltrimethoxysilane, vinyltriethoxysilane, 3-glycidoxypropyl-trimethoxysilane, 3-methacryloxypropyltrimethoxysilane and 3-acryloxy-propyltrimethoxysilane.

The photo-initiator is not particularly limited and can be suitably selected as desired from photo-initiators conventionally used for resins of the ultraviolet light curing type. Examples of the photo-initiator include benzoins, benzophenones, acetophenones, a-hydroxyketones, a-amino-ketones, α-diketones, α-diketone dialkyl acetals, anthraquinones, thioxanthones and other like compounds.

The photo-initiator may be used singly or in combination of two or more. The amount is suitably selected, in general, in the range of 0.01 to 30 parts by mass and preferably in the range of 0.05 to 20 parts by mass based on 100 parts by mass of the total of the amounts of the silicone resin of the addition reaction type and the crosslinking agent.

For forming the releasing agent layer comprising the silicone-based releasing agent described above on at least one of the faces of the substrate film, as the first step, a coating fluid of the silicone-based releasing agent of the solvent type or a coating fluid of the silicone-based releasing agent of the emulsion type is prepared.

In the coating fluid of the silicone-based releasing agent of the solvent type, in general, toluene, hexane, ethyl acetate, methyl ethyl ketone, heptane or a mixture of these solvents is used as the diluent. In the coating fluid of the silicone-based releasing agent of the emulsion type, in general, water is used as the diluent. The viscosity of the coating fluid is adjusted at a value suitable for the coating.

Silica, antistatic agents, dyes, pigments and other additives may be added to the coating fluid of the silicone-based releasing agent, where necessary. The coating fluid of the silicone-based releasing agent thus prepared is applied to one face of the substrate film, for example, in accordance with the gravure coating process, the bar coating process or the multi-roll coating process. As the amount of the coating, 0.01 to 3 g/m² is suitable, and 0.03 to 1 g/m² is preferable, as expressed as the amount of the solid components.

To cure the coating fluid of the silicone-based releasing agent coating the face of the substrate film, the coating fluid may be treated by heating in an oven of a coating machine or treated by irradiation with ultraviolet light after the heating. The irradiation after the heating is preferable from the standpoint of preventing formation of wrinkles due to heat shrinkage, the curing property of the silicone and adhesion of the releasing agent to the substrate film.

When the irradiation with ultraviolet light is used in combination, it is preferable that a releasing agent containing a photo-initiator is used or a photo-initiator is added when the coating fluid is prepared. As the photo-initiator added when the coating fluid is prepared, the photo-initiators described above as the photo-initiator added to the silicone-based releasing agent where necessary can be used.

When the curing is conducted by heating alone, it is suitable that the heating is conducted at a temperature in the range of about 70 to 160° C. for a time necessary for the sufficient curing. When the curing is conducted by the combination of the heating and the irradiation with ultraviolet light, the temperature of the heating can be lowered to a temperature of about 50 to 120° C.

For the irradiation with ultraviolet light, for example, a high voltage mercury lamp, a metal halide lamp, a high power metal halide lamp or an electrodeless discharge lamp can be used. The electrodeless discharge lamp is referable due to the excellent curing property of the silicone-based releasing agent. The output of ultraviolet light can be suitably selected. It is preferable that the output of the ultraviolet light is 50 W/cm to 360 W/cm.

The thickness of the releasing agent layer constituted with the silicone-based releasing agent thus formed is, in general, about 0.01 to 3 μm and preferably 0.03 to 0.5 μm from the standpoint of the property of forming a uniform film, prevention of blocking, the releasing property and adhesion with the substrate film.

In the release film of the present invention having the releasing agent layer formed on at least one face of the substrate film as described above, it is necessary that the hardness of the releasing agent layer be 0.07 GPa or smaller as measured in accordance with the nano indentation test. When the hardness exceeds 0.7 GPa, zipping tends to takes place when the release film attached to the face of the pressure sensitive adhesive layer is peeled off, and the object of the present invention is not achieved. When the hardness is excessively small, it is difficult that the function as the release film is sufficiently exhibited. It is preferable that the hardness is in the range of 0.05 to 0.065 GPa as measured in accordance with the nano indentation test.

The measurement of the hardness in accordance with the nano indentation test is effective for the measurement of the hardness of a thin coating film having a thickness of about 10 nm to 1,000 nm, and the hardness of the coating film can be measured without being affected with the substrate film.

It is necessary that the peeling force has an average value of 100 mN/20 mm or greater and stays within ±7% of the average value when a piece of the release film having a width of 20 mm and a length of 150 mm is peeled from a pressure sensitive adhesive layer at an angle of 180° with respect to the face of the pressure sensitive adhesive layer at a speed of 0.3 m/minute in the measurement of the peeling force from the pressure sensitive adhesive layer.

In the present invention, it is necessary for sufficiently exhibiting the effect of suppressing zipping that the average value of the peeling force measured under the above condition be 100 mN/20 mm or greater. When the average value of the peeling force is smaller than 100 mN/20 mm, the peeling force is excessively small, and the zipping does not take place. This condition is not suitable with respect to the object of the present invention which is prevention of the zipping. It is preferable that the average value of the peeling force is in the range of 120 to 300 mN/20 mm.

It is necessary that the peeling force obtained by the measurement stay entirely within ±7% of the average value. When the peeling force values comes outside this range, the zipping tends to take place. It is preferable that the peeling force stays within ±5% of the average value.

The measurement of the hardness in accordance with the nano indentation test and the measurement of the peeling force will be described specifically below.

The release film of the present invention having the properties described above prevents the zipping when the release film is peeled from the face of the pressure sensitive adhesive layer. Therefore, striation on the face of the pressure sensitive adhesive layer is prevented, and fluctuation in the peeling force during the peeling is small.

The present invention also provides the process for producing the release film of the present invention having the properties described above. The process comprises coating at least one of the faces of a substrate film with a coating fluid comprising a releasing agent and drying the formed coating layer to form a releasing agent layer.

### EXAMPLES

The present invention will be described more specifically with reference to examples in the following. However, the present invention is not limited to the examples.

The properties of release films obtained in Examples and Comparative Examples were evaluated in accordance with the following methods.

(1) Measurement of the Hardness in Accordance with the Nano Indentation Test

After a release film was treated for adjustment of moisture at 23° C. under 50% RH for one week, a sample was prepared by cutting the conditioned release film into a piece having a size of 10 mm×10 mm. The face of the sample opposite to the face having the releasing agent layer was fixed to a glass plate adhered to a fixing plate made of aluminum with a two component epoxy adhesive, and the hardness of the releasing agent layer was measured using a nano indenter [manufactured by MTS Systems Corporation; the name of the apparatus: “NANO INDENTER SA2”].

(2) Measurement of the Peeling Force

The face of a releasing agent layer of a release film was coated with a pressure sensitive adhesive by a doctor blade in an amount such that the thickness was 10 g/m² after being dried, and the formed coating layer was dried by heating at 100° C. for 2 minutes to form a layer of the pressure sensitive adhesive. The layer of the pressure sensitive adhesive was transcribed to a polyethylene terephthalate film having a thickness of 50 μm [manufactured by MITSUBISHI POLYESTER FILM Corporation; the trade name: “PET50 T-100”], and a pressure sensitive adhesive sheet having a release film was prepared.

After the prepared pressure sensitive adhesive sheet having a release film was treated for adjustment of moisture at 23° C. under 50% RH for one week, a test sample was prepared by cutting the conditioned sheet into a piece having a width of 20 mm and a length of 150 mm.

Using the prepared test sample, the measurement of the peeling force was conducted using a tensile tester [manufactured by A & D Co., LTD; “TENSILON TA-T-2M”] as shown in the following. The release film in the pressure sensitive adhesive sheet was peeled in accordance with the method of Japanese Industrial Standard Z 0237 at an angle of 180° at a speed of 0.3 m/minute. The force required to the peeling (the peeling force) was measured with time from the start of the peeling to the end of the peeling. The average value of the peeling force (Fa) was obtained, and the fractional deviation (Dmax) of the maximum peeling force (Fmax) from Fa and the fractional deviation (Dmin) of the minimum peeling force (Fmin) from Fa were calculated using the equations shown below.

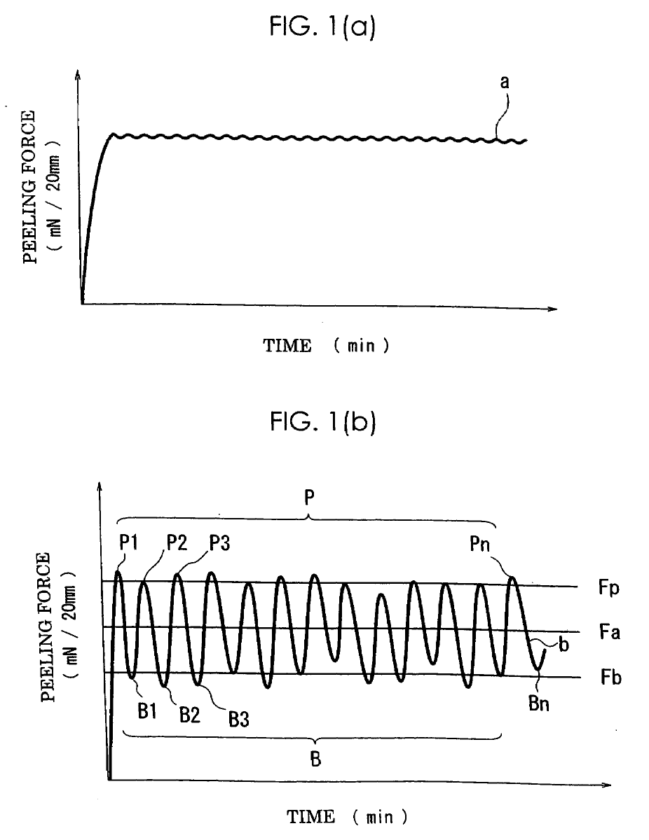

The average value of the peeling force was obtained as follows. FIG. 1(a) shows a diagram exhibiting the relation between the time and the releasing force in the measurement of the peeling force when zipping does not take place. Fa was obtained as the average value a of the entire points of the measurement. FIG. 1(b) shows a diagram exhibiting the relation between the time and the releasing force in the measurement of the peeling force when zipping takes place. In this case, the average value Fp of the maximum releasing forces P1, P2, P3 . . . Pn at each peak points of the measurement and the average value Fb of the minimum releasing forces B1, B2, B3 . . . Bn at each bottom points of the measurement were obtained. The average value Fa was obtained as:

Fa=(Fp+Fb)/2.

Dmax(%)=[(Fmax−Fa)/Fa]×100

Dmin(%)=[(Fmin−Fa)/Fa]×100

The presence or the absence of the striation was found by visual observation of the face of the pressure sensitive adhesive layer after the release film was peeled off, and the prevention of the zipping (the presence or the absence of the zipping) was evaluated in accordance with the following criterion:

good: no striation found

poor: striation found

The pressure sensitive adhesives used for the measurement of the peeling force were as follows:

Pressure sensitive adhesive A: An adhesive prepared by diluting a copolymer obtained by copolymerization of 87 parts by mass of 2-ethylhexyl acrylate, 10 parts by mass of vinyl acetate and 3 parts by mass of acrylic acid with toluene.

Pressure sensitive adhesive B: An adhesive prepared by diluting a copolymer obtained by copolymerization of 55 parts by mass of butyl acrylate and 45 parts by mass of 2-ethylhexyl acrylate with toluene.

### EXAMPLE 1

A mixture obtained by mixing 21 parts by mass of an agent for release adjustment (an additive for release under a greater force) [manufactured by DOW CORNING TORAY Co., Ltd.; the trade name: “SD7292”; the solid content: 65% by mass] into 55 parts by mass of a silicone resin of the addition reaction type [manufactured by DOW CORNING TORAY Co., Ltd.; the trade name: “SD7328”; the solid content: 30% by mass] was dissolved into toluene. To the resultant solution, 2 parts by mass of a platinum catalyst [manufactured by DOW CORNING TORAY Co., Ltd.; the trade name: “SRX-212”; the solid content: 100% by mass] and 1.9 parts by mass of an Si—H crosslinking agent [manufactured by DOW CORNING TORAY Co., Ltd.; the trade name: “SP7297”; the solid content: 100% by mass] were added, and a coating fluid of a releasing agent having a solid content of 1.5% by mass was prepared.

The prepared coating fluid of a releasing agent was applied to a polyethylene terephthalate film having a thickness of 50 μm [manufactured by MITSUBISHI POLYESTER FILM Corporation; the trade name: “PET50 T-100”]. The formed coating layer was cured by heating at 135° C. for 1 minute to form a releasing agent layer having a thickness of 0.2 μm, and a release film was prepared. The hardness of the releasing agent layer in the prepared release film was measured in accordance with the nano indentation test. The hardness was obtained by pushing the pressing rod into the face of the releasing agent layer to the depth of 20% of the thickness of the releasing agent layer.

Using the release film prepared above and Pressure sensitive adhesive A, a pressure sensitive adhesive sheet having the release film was prepared, and the measurement of the peeling force was conducted.

The results are shown in Table 1.

### EXAMPLE 2

A release film was prepared in accordance with the same procedures as those conducted in Example 1 except that the amount of the silicon resin of the addition reaction type was changed to 50 parts by mass, the amount of the agent for release adjustment (the additive for release under a greater force) was changed to 23 parts by mass, and the amount of the Si—H crosslinking agent was changed to 2.2 parts by mass, and the measurements of the hardness in accordance with the nano indentation test and the peeling force were conducted with respect to the releasing agent layer. The results are shown in Table 1.

### EXAMPLE 3

A release film was prepared in accordance with the same procedures as those conducted in Example 1 except that the amount of the silicon resin of the addition reaction type was changed to 40 parts by mass, the amount of the agent for release adjustment (the additive for release under a greater force) was changed to 28 parts by mass, the amount of the Si—H crosslinking agent was changed to 2.6 parts by mass, and 10 parts by mass of an additive for release under a smaller force [manufactured by DOW CORNING TORAY Co., Ltd.; the trade name: “BY24-850”; the solid content: 30% by mass] was added, and the measurements of the hardness in accordance with the nano indentation test and the peeling force were conducted with respect to the releasing agent layer. The results are shown in Table 1.

### EXAMPLE 4

A release film was prepared in accordance with the same procedures as those conducted in Example 1 except that Pressure sensitive adhesive B was used in place of Pressure sensitive adhesive A used in Example 1, and the measurements of the hardness in accordance with the nano indentation test and the peeling force were conducted with respect to the releasing agent layer. The results are shown in Table 1.

### EXAMPLE 5

A release film was prepared in accordance with the same procedures as those conducted in Example 2 except that Pressure sensitive adhesive B was used in place of Pressure sensitive adhesive A used in Example 2, and the measurements of the hardness in accordance with the nano indentation test and the peeling force were conducted with respect to the releasing agent layer. The results are shown in Table 1.

### EXAMPLE 6

A release film was prepared in accordance with the same procedures as those conducted in Example 3 except that Pressure sensitive adhesive B was used in place of Pressure sensitive adhesive A used in Example 3, and the measurements of the hardness in accordance with the nano indentation test and the peeling force were conducted with respect to the releasing agent layer. The results are shown in Table 1.

### COMPARATIVE EXAMPLE 1

A release film was prepared in accordance with the same procedures as those conducted in Example 1 except that a coating fluid prepared by adding 0.5 parts by mass of the platinum catalyst “SRX-212” (described above) to 100 parts by mass of a silicone resin of the addition reaction type [manufactured by DOW CORNING TORAY Co., Ltd.; the trade name: “SRX-370”; the solid content: 15% by mass] was used as the coating fluid of a releasing agent, and the measurements of the hardness in accordance with the nano indentation test and the peeling force were conducted with respect to the releasing agent layer. The results are shown in Table 1.

### COMPARATIVE EXAMPLE 2

A release film was prepared in accordance with the same procedures as those conducted in Comparative Example 1 except that Pressure sensitive adhesive B was used in place of Pressure sensitive adhesive A used in Comparative Example 1, and the measurements of the hardness in accordance with the nano indentation test and the peeling force were conducted with respect to the releasing agent layer. The results are shown in Table 1.

TABLE 1

| | | | | Hardness | |
|---|---|---|---|---|---|
| | Measurement of peeling force | | | of releasing | |
| | | fractional | fractional | agent layer | |
| | average value | deviation | deviation | by nano- | Prevention |
| | of peeling force | from Fa | from Fa | indentation | of zipping |
| | [Fa] | [Dmax] | [Dmin] | test | (presence or |
| | (mN/20 mm) | (%) | (%) | (GPa) | absence of zipping) |
| Example 1 | 130 | 5 | −5 | 0.060 | good |
| Example 2 | 195 | 4 | −4 | 0.061 | good |
| Example 3 | 250 | 2 | −2 | 0.058 | good |
| Example 4 | 140 | 5 | −5 | 0.060 | good |
| Example 5 | 160 | 4 | −4 | 0.061 | good |
| Example 6 | 200 | 3 | −3 | 0.058 | good |
| Comparative | 285 | 58 | −58 | 0.085 | poor |
| Example 1 | | | | | |
| Comparative | 225 | 56 | −56 | 0.085 | poor |
| Example 2 | | | | | |

### INDUSTRIAL APPLICABILITY

The release film of the present invention can prevent striation on the face of the pressure sensitive adhesive layer by suppressing zipping when the release film is peeled from the face of the pressure sensitive adhesive layer.

1. A release film comprising a releasing agent layer which is disposed on at least one of faces of a substrate film and has a hardness of 0.07 GPa or smaller as measured in accordance with a nano indentation test, wherein peeling force has an average value of 100 mN/20 mm or greater and stays within ±7% of the average value when a piece of the release film having a width of 20 mm and a length of 150 mm is peeled from a pressure sensitive adhesive layer at an angle of 180° with respect to a face of the pressure sensitive adhesive layer at a speed of 0.3 m/minute in measurement of the peeling force from the pressure sensitive adhesive layer.

2. The release film according to claim 1, wherein the hardness measured in accordance with the nano indentation test is 0.05 to 0.065 GPa.

3. The release film according to claim 1, wherein the average value of the peeling force is 120 to 300 mN/20 mm.

4. The release film according to claim 1, wherein a releasing agent constituting the releasing agent layer is a silicone-based releasing agent.

5. The release film according to claim 1, wherein a thickness of the releasing agent layer is 0.01 to 3 μm.

6. A process for producing a release film described in claim 1, which comprises coating at least one of faces of a substrate film with a coating fluid comprising a releasing agent and drying a formed coating layer to form a releasing agent layer.

7. The release film according to claim 4, wherein the silicone-based releasing agent is an agent of the addition reaction type which is obtained by adding a crosslinking agent and a catalyst to the main component comprising a silicone resin of the addition reaction type.

8. The release film according to claim 7, wherein the silicone resin of the addition reaction type further comprises an agent for release adjustment selected from the group consisting of (i) MQ resins having a resin structure having M unit comprising the unit of R¹R²R³SiO_{1/2} (R¹, R² and R³ each independently representing a alkyl group having 1 to 10 carbon atoms which may have a functional group selected from the group consisting of hydroxy group, cyano group and epoxy group or vinyl group) and Q unit comprising the unit of SiO_{4/2} and (ii) substances having a silica structure comprising a unit of SiO_{4/2}.
